(19) United States
(12) Patent Application Publication
(10) Pub. No.: US 2026/0038798 A1
(43) Pub. Date: Feb. 5, 2026

(54) APPARATUS AND METHOD FOR MANUFACTURING ELECTRODE PLATE

(71) Applicant: SAMSUNG SDI CO., LTD., Yongin-si (KR)

(72) Inventor: Hyung Chun LEE, Yongin-si (KR)

(21) Appl. No.: 19/214,679

(22) Filed: May 21, 2025

(30) Foreign Application Priority Data
Jul. 31, 2024 (KR) 10-2024-0101378

(51) Int. Cl. H01M 4/04

(52) U.S. Cl. CPC H01M 4/0435

(57) ABSTRACT

An apparatus for manufacturing an electrode plate, the apparatus including a transport part configured to transport an electrode plate coated with an active material in one direction, a vibration generation part configured to generate a vibration to the electrode plate, and a rolling part configured to apply pressure in a thickness direction of the electrode plate to reduce a thickness of the electrode plate to which the vibration is applied.

### CROSS-REFERENCE TO RELATED APPLICATION

This application claims priority under 35 U.S.C § 119 to Korean Patent Application No. 10-2024-0101378, filed in the Korean Intellectual Property Office on Jul. 31, 2024, the entire contents of which are hereby incorporated by reference.

### BACKGROUND

### 1. Field

Embodiments relate to an apparatus and method for manufacturing an electrode plate.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

In general, the electrode of the secondary battery is formed through a mixing process of mixing raw materials for an electrode, a coating process of applying mixed slurry to a substrate of an electrode plate and drying the mixed slurry, a rolling process of reducing the thickness of the coated electrode, a slitting process of cutting the electrode, and a notching process of forming tabs in the electrode.

The above information disclosed in this Background section is for enhancement of understanding of the background of the present disclosure, and therefore, it may contain information that does not constitute related (or prior) art.

### SUMMARY

Embodiments include an apparatus for manufacturing an electrode plate, the apparatus including a transport part configured to transport an electrode plate coated with an active material in one direction, a vibration generation part configured to generate a vibration to the electrode plate, and a rolling part configured to apply pressure in a thickness direction of the electrode plate to reduce a thickness of the electrode plate to which the vibration is applied.

The vibration generation part may include a vibration generator configured to generate the vibration to the electrode plate, and a control part configured to control one of frequency and intensity of the vibration generated by the vibration generator.

The vibration generator may include at least one of an ultrasonic wave generator and an air blower.

The rolling part may include a pair of rollers in close contact with each other, the pair of rollers rolling the electrode plate, and the control part may be configured to control the frequency of the vibration based on rotation speeds of the pair of rollers.

The control part may be configured to control the frequency of the vibration in proportion to the rotation speeds of the pair of rollers.

A transport speed of the electrode plate by the transport part may be proportional to the rotation speeds of the pair of rollers.

The vibration generation part may be positioned ahead of the rolling part along a transport direction of the electrode plate, and a separation distance between the vibration generation part and the rolling part may be preset so that the vibration applied to the electrode plate is maintained.

The vibration generation part may be configured to generate the vibration from one end of the electrode plate to an opposite end of the electrode plate along a width direction of the electrode plate, the width direction being perpendicular to a transport direction of the electrode plate.

The apparatus may further include an electrode plate inspection part configured to inspect one of a thickness change rate of the electrode plate after passing through the rolling part and a deformation state of the electrode plate.

The electrode plate inspection part may include a thickness change rate information generation part configured to generate thickness change rate information of the electrode plate, an electrode plate deformation state information generation part configured to generate deformation state information of the electrode plate, and a communication part configured to transmit the thickness change rate information of the electrode plate or the deformation state information of the electrode plate to the vibration generation part.

The thickness change rate information generation part may include a first sensor configured to measure a thickness of the electrode plate, and a change rate calculation part configured to calculate a thickness change rate of the electrode plate.

The electrode plate deformation state information generation part may include a second sensor configured to photograph the electrode plate, the second sensor generating an electrode plate image, and a deformation state determination part configured to determine a deformation state of the electrode plate based on the electrode plate image.

The vibration generation part may include a communication part configured to receive one of the thickness change rate of the electrode plate and deformation state information of the electrode plate from the electrode plate inspection part, a vibration generator configured to generate vibration to the electrode plate, and a control part configured to control one of frequency and intensity of the vibration generated by the vibration generation part based on one of the thickness change rate of the electrode plate and the deformation state information of the electrode plate.

Embodiments include a method for manufacturing an electrode plate, the method including transporting, by a transport part, an electrode plate coated with an active material in one direction, generating, by a vibration generation part, vibration to the electrode plate, and applying, by a rolling part, pressure in a thickness direction of the electrode plate to reduce a thickness of the electrode plate to which the vibration is applied, the applying resulting in a rolled electrode plate.

The generating of the vibration to the electrode plate may include generating vibration to the electrode plate by at least one of an ultrasonic wave generator and an air blower.

The rolling part may include a pair of rollers in contact with each other, the rolling part rolling the electrode plate, and wherein the generating of the vibration to the electrode plate comprises controlling, by the vibration generation part, a frequency of the vibration based on rotation speeds of the pair of rollers.

The vibration generation part may be configured to generate vibration from one end of the electrode plate to an opposite end of the electrode plate along a width direction of the electrode plate, the width direction being perpendicular to a transport direction of the electrode plate.

The method may further include inspecting one of a thickness change rate of the rolled electrode plate and a deformation state of the electrode plate.

The inspecting of the thickness change rate of the electrode plate may include measuring the thickness of the rolled electrode plate and generating thickness change rate information of the electrode plate based on the measured thickness, and the inspecting of the deformation state of the electrode plate may include capturing an image of the electrode plate and generating electrode plate deformation state information based on the captured image.

The generating of the vibration to the electrode plate may include controlling, by the vibration generation part, one of frequency and intensity of the vibration based on information about the thickness change rate of the electrode plate and information about the deformation state of the electrode plate.

However, the technical problem to be solved by the present disclosure is not limited to the above problem, and other problems not mentioned herein, and aspects and features of the present disclosure that would address such problems, will be clearly understood by those skilled in the art from the description of the present disclosure below.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 illustrates an apparatus for manufacturing an electrode plate according to an embodiment of the present disclosure.

FIG. 2 illustrates the configuration of the vibration generation part according to an embodiment of the present disclosure.

FIG. 3 illustrates the arrangement of the vibration generation part and the rolling part in the apparatus for manufacturing the electrode plate according to an embodiment of the present disclosure.

FIG. 4 illustrates an apparatus for manufacturing an electrode plate according to an embodiment of the present disclosure.

FIG. 5 illustrates the configuration of the electrode plate inspection part according to an embodiment of the present disclosure.

FIG. 6 illustrates an example of the thickness change rate information generation part according to an embodiment of the present disclosure.

FIG. 7 illustrates an example of the electrode plate deformation state information generation part according to an embodiment of the present disclosure.

FIG. 8 illustrates a method for manufacturing an electrode plate according to another embodiment of the present disclosure.

FIG. 9 illustrates an example of the method for generating the thickness change rate information of the electrode plate according to another embodiment of the present disclosure.

FIG. 10 illustrates an example of the method for generating the electrode plate deformation state information according to another embodiment of the present disclosure.

FIG. 11 illustrates an example of the method for controlling the vibration frequency of the electrode plate according to another embodiment of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

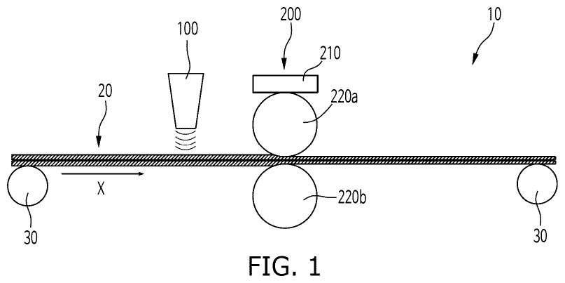

FIG. 1 illustrates an apparatus for manufacturing an electrode plate according to an embodiment of the present disclosure.

Referring to FIG. 1, an apparatus 10 for manufacturing an electrode plate according to an embodiment of the present disclosure may include a transport part 30, a vibration generation part 100, and a rolling part 200.

An electrode plate 20 manufactured by the apparatus 10 for manufacturing the electrode plate may be a positive electrode or a negative electrode. In a case where the electrode plate 20 is a positive electrode, the electrode plate 20 may be formed by applying an active material such as a transition metal oxide to a current collector plate formed of a metal foil such as aluminum or an aluminum alloy. Uncoated portions in which no active material is applied may be formed at both ends of the electrode plate 20. In a case where the electrode plate 20 is a negative electrode, the electrode plate 20 may be formed by applying an active material such as graphite or carbon to a current collector plate formed of a metal foil such as copper, a copper alloy, nickel, or a nickel alloy. Uncoated portions in which no active material is applied may be formed at both ends of the electrode plate 20.

The transport part 30 may transport the electrode plate 20 coated with an active material in one direction (e.g., the X direction). For example, the transport part 30 may include a plurality of transport rollers connected to a driving motor and may transport the coated electrode plate 20 in the one direction. As another example, the transport part 30 may include a conveyor belt connected to a driving motor and transport the coated electrode plate 20 in the one direction, but the transport part 30 may take various forms.

The driving motor that provides power to the transport roller of the transport part 30 and the driving motor that provides power to rolling roller 220a and 220b of the rolling part 200 described later may have separate structures or may have different gear ratios as one structure, but the design thereof may vary.

The rotation speed of the transport roller of the transport part 30 may be proportional to the rotation speed of the rolling rollers (or just “rollers”) 220a and 220b of the rolling part 200. The rotation speed of the transport roller of the transport part 30 may be proportional to the transport speed of the electrode plate 20. Accordingly, the transport speed of the electrode plate 20 may be proportional to the rotation speed of the rolling rollers.

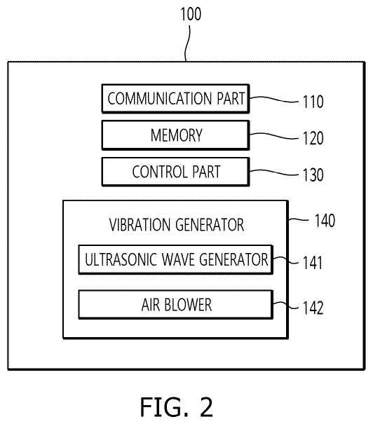

The vibration generation part 100 may generate vibration to the electrode plate 20. The vibration applied to the electrode plate 20 may be, for example, a micro-vibration having a frequency of 500 Hz or more, but the vibration applied may vary. The vibration generation part 100 may generate vibration corresponding to ultrasonic waves or sound waves to the electrode plate 20, but the type of wave may vary. For example, the vibration generation part 100 may include an ultrasonic wave generator 141 (see FIG. 2) that generates ultrasonic vibration. In another example, the vibration generation part 100 may include a blower or an air blower that generates gas, such as air, which includes sonic or ultrasonic vibration.

In an embodiment, the vibration generation part 100 may generate, to (e.g., toward) the electrode plate 20, ultrasonic or sonic vibration with a frequency and/or output intensity adjusted according to the transport speed of the electrode plate 20. In a case where the transport speed of the electrode plate 20 increases, the vibration generation part 100 may increase the frequency and/or intensity of vibration. In a case where the transport speed of the electrode plate 20 decreases, the vibration generation part 100 may decrease the frequency and/or intensity of vibration.

As described above, the transport speed of the electrode plate 20 may be proportional to the rotation speed of the rolling roller of the rolling part 200. In a case where the transport speed of the electrode plate 20 increases, the rotation speed of the rolling roller may increase, and in a case where the transport speed of the electrode plate 20 decreases, the rotation speed of the rolling roller may decrease. Accordingly, the vibration generation part 100 may generate, to the electrode plate 20, vibration with a frequency or output intensity adjusted in proportion to the rotation speed of the rolling roller.

Since the vibration generation part 100 having the structure described above generates vibration to the electrode plate 20 being transported toward the rolling part 200, the electrode plate 20 may be rolled by the rolling part 200 while vibrating. In this manner, the electrode plate 20 may be rolled while vibrating, and thus, stress applied to the electrode plate 20 may be reduced or prevented from accumulating.

The rolling part 200 shown in FIG. 1 may apply pressure in the thickness direction of the electrode plate 20 to thin the thickness of the electrode plate 20 to which vibration is applied. To this end, the rolling part 200 may include a pair of rolling rollers and a rolling control part 210 that controls the rolling rollers. The pair of rolling rollers may be disposed on the upper and lower surfaces of the electrode plate 20. The pair of rolling rollers may roll the electrode plate 20 by applying pressure while pressing against both surfaces (e.g., top and bottom in the orientation of FIG. 1) of the electrode plate 20. The pair of rolling rollers may be disposed to have a preset separation gap therebetween. The electrode plate 20 transported by the transport part 30 may be inserted into the separation gap between the pair of rolling rollers, and the pair of rolling rollers may apply pressure to the inserted electrode plate 20 to bring an active material into contact with the metal foil of the electrode plate 20.

The rolling control part 210 may control the rotation speed, pressure strength, and separation gap of the rolling rollers 220a and 220b. The rolling control part 210 may control the rotation speed of the rolling rollers based on the transport speed of the electrode plate 20. The rolling rollers 220a and 220b may receive information about the transport speed of the electrode plate 20 from the transport part 30. For example, in a case where the transport speed of the electrode plate 20 increases, the rolling control part 210 may increase the rotation speed of the rolling rollers. As another example, in a case where the transport speed of the electrode plate 20 decreases, the rolling control part 210 may decrease the rotation speed of the rolling rollers, but control of the rolling rollers may vary. The rolling control part 210 may also control the strength of the pressure applied to the electrode plate 20 by the rolling rollers and the separation gap between the in rolling rollers, based on information about the substrate and active material of the electrode plate 20.

As illustrated in FIG. 1, the vibration generation part 100 may be disposed before (e.g., ahead of) the rolling part 200 along the transport direction of the electrode plate 20, and the separation distance between the vibration generation part 100 and the rolling part 200 may be preset so that the vibration applied to the electrode plate 20 may be maintained. For example, the separation distance between the vibration generation part 100 and the rolling part may be set to about 0.1 m to 0.5 m, but the separation distance may vary. The separation distance between the vibration generation part 100 and the rolling part may be changed based on the frequency and/or intensity of the vibration generated by the vibration generation part 100, the type and material of the electrode plate 20, etc.

Since the apparatus 10 for manufacturing the electrode plate, which has the configuration described above, generates vibration having an appropriate frequency and/or intensity to the electrode plate 20 in the rolling process of the electrode plate 20, stress may be reduce or prevented from accumulating in the electrode plate 20, thereby preventing deformation such as curling, folding, bending, or wrinkles from occurring in the electrode plate 20.

FIG. 2 illustrates the configuration of the vibration generation part according to an embodiment of the present disclosure.

Referring to FIGS. 1 and 2, the vibration generation part 100 according to an embodiment of the present disclosure may include a communication part 110, a memory 120, a control part 130, and a vibration generator 140.

The communication part 110 may be a device capable of wired or wireless communication with other components of the apparatus 10 for manufacturing the electrode plate. For example, the communication part 110 may wirelessly communicate with other components of the apparatus 10 for manufacturing the electrode plate by using wireless communication such as Bluetooth, Radio Frequency Identification (RFID), Infrared Data Association, Ultra Wideband (UWB), ZigBee, Near Field Communication (NFC), Wireless-Fidelity (Wi-Fi), Wi-Fi Direct, Wireless Universal Serial Bus (USB), etc., but the communication method may vary. For example, the communication part 110 may receive the rotation speed of the transport roller from the transport part 30 and the rotation speed of the rolling roller from the rolling part 200. In addition, the communication part 110 may receive information about the substrate and active material of the transported electrode plate through an external interface.

The memory 120 may store process information for the control part 130 for controlling the operation of the vibration generator 140. For example, the memory 120 may store information about the intensity or frequency of vibration determined based on the rotation speed of the transport roller, the transport speed of the electrode plate, the rotation speed of the rolling roller, and information related to the substrate and active material of the electrode plate, but the memory may store various information.

The control part 130 may control the operation of the vibration generator 140. The control part 130 may control either the frequency and/or intensity of the vibration generated by the vibration generator 140. For example, in a case where the vibration generator 140 includes a vibrator that converts an electrical signal into a mechanical signal, the control part 130 may transmit, to the vibrator, an electrical signal that may control the vibrator to generate vibration of a specific frequency and/or intensity.

The control part 130 may control the vibration frequency based on the rotation speed of the rolling roller. The control part 130 may control the increase or decrease of the vibration frequency in proportion to the rotation speed of the rolling roller. For example, the control part 130 may receive information about the rotation speed of the rolling roller from the communication part 110. In a case where the rotation speed of the rolling roller increases, the control part 130 may control the vibration generator 140 so that the frequency of vibration occurring on the electrode plate 20 increases. As another example, in a case where the rotation speed of the rolling roller decreases, the control part 130 may control the vibration generator 140 so that the frequency of vibration occurring on the electrode plate 20 decreases.

The vibration generator 140 may generate vibration to the electrode plate 20. The vibration generator 140 may include one of an ultrasonic wave generator 141 and an air blower 142, but the vibration generator 140 may include various devices capable of generating vibration through an appropriate medium. For example, the ultrasonic wave generation part may output ultrasonic waves to generate vibration to the electrode plate 20. As another example, the air blower 142 may output air to generate vibration to the electrode plate 20.

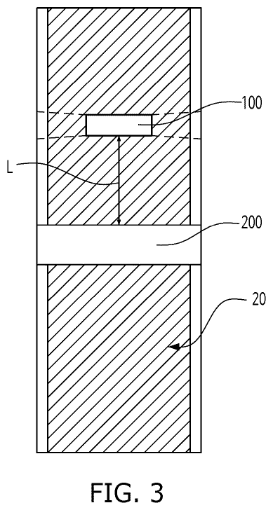

FIG. 3 illustrates the arrangement of the vibration generation part and the rolling part in the apparatus for manufacturing the electrode plate according to an embodiment of the present disclosure.

Referring to FIG. 3 (a top-down view), the vibration generation part 100 according to an embodiment of the present disclosure may be disposed before (or ahead of) the rolling part 200 along the transport direction of the electrode plate.

The vibration generation part 100 may be disposed apart from the rolling part 200. A separation distance L between the vibration generation part 100 and the rolling part 200 may be a distance set in advance so that the vibration applied to the electrode plate may be maintained while the electrode plate is being inserted into the rolling part 200. For example, the time that the vibration applied to the electrode plate is maintained may vary depending on the substrate of the electrode plate and the properties of the active material.

In addition, the separation distance L between the vibration generation part 100 and the rolling part 200 may increase or decrease depending on the time that the vibration is maintained and the speed at which the electrode plate is transported. For example, as the time that the vibration is maintained increases or the transport speed of the electrode plate increases, the separation distance L may increase. In contrast, as the time that the vibration is maintained decreases or the transport speed of the electrode plate decreases, the separation distance L may decrease.

The vibration generation part 100 may be a linear or line-shaped vibration generation device capable of generating vibration from one end to the other (opposite) end of the electrode plate along the width direction of the electrode plate perpendicular to the transport direction of the electrode plate. For example, the vibration generation part 100 may be an ultrasonic wave generation device including a plurality of vibrators disposed in a row along the width direction of the electrode plate. In another example, the vibration generation part 100 may be an air blower 142 including a plurality of air injection nozzles disposed in a row along the width direction of the electrode plate.

During the rolling process, deformation may occur most on both sides (e.g., the top and bottom) in the width direction of the electrode plate due to the step difference between the coated portion where the active material is applied to the substrate of the electrode plate and the uncoated portion where the active material is not applied (located at both ends of the electrode plate). Accordingly, the vibration generation part 100 may be a linear or line-shaped vibration generation device having a length sufficient to cover the coated portion where the active material is applied along the width direction of the electrode plate. The vibration generation part 100 having such a configuration may be used to generate vibration from one end to the other end in the width direction of the electrode plate, thereby minimizing deformation of the electrode plate.

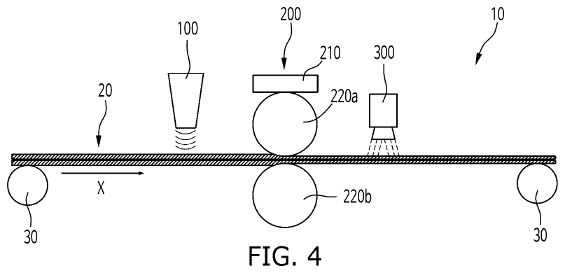

FIG. 4 illustrates an apparatus for manufacturing an electrode plate according to an embodiment of the present disclosure.

Referring to FIG. 4, an apparatus 10 for manufacturing an electrode plate according to an embodiment of the present disclosure may include a transport part 30, a vibration generation part 100, a rolling part 200, and an electrode plate inspection part 300. The transport part 30 and the rolling part 200 of the apparatus 10 for manufacturing the electrode plate illustrated in FIG. 4 have substantially the same configuration and function as the corresponding components of the apparatus 10 for manufacturing the electrode plate illustrated in FIG. 1. Hereinafter, the specific configurations of the transport part 30 and the rolling part 200 are omitted, and the description focuses on the vibration generation part 100 and the electrode plate inspection part 300.

The electrode plate inspection part 300 may inspect a thickness change rate of the electrode plate having passed through the rolling part 200 or a deformation state of the electrode plate.

Specifically, the electrode plate inspection part 300 may generate thickness change rate information of the electrode plate. For example, the thickness change rate information may include information indicating the degree to which the active material is in close contact with the substrate of the electrode plate before/after rolling by the rolling part 200. The electrode plate inspection part 300 may transmit the thickness change rate information of the electrode plate to the vibration generator 140 (see FIG. 2).

In addition, the electrode plate inspection part 300 may generate deformation state information of the electrode plate. For example, the deformation state information of the electrode plate may include information on the degree to which curling, folding, bending, wrinkling, etc. have occurred in the electrode plate, compared to an electrode plate in a normal state. The electrode plate inspection part 300 may transmit the deformation state information of the electrode plate to the vibration generator 140.

The electrode plate inspection part 300 may transmit the thickness change rate information and/or the deformation state information of the rolled electrode plate to the vibration generation part 100 in real time. The vibration generation part 100 may effectively roll the electrode plate by controlling the frequency and/or intensity of vibration generated in the electrode plate based on the thickness change rate information and/or the deformation state information of the rolled electrode plate.

The vibration generation part 100 may receive information about the rolled electrode plate from the electrode plate generation part. The vibration generation part 100 may receive the thickness change rate information of the electrode plate and/or the deformation state information of the electrode plate from the electrode plate generation part. The vibration generation part 100 may control the frequency and/or intensity of vibration generated for the electrode plate based on the received thickness change rate information of the electrode plate and/or the received deformation state information of the electrode plate. For example, the vibration generation part 100 may increase the intensity of vibration in a case where the thickness of the rolled electrode plate is thicker than the target thickness of the electrode plate, based on the thickness change rate information of the electrode plate. As another example, the vibration generation part 100 may increase the intensity of vibration in a case where the rolled electrode plate has more curl than the normal electrode plate, based on the deformation state information of the electrode plate. The control operation of the frequency and intensity of vibration by the vibration generator 140 described above is only an example, and the control operation can take various forms.

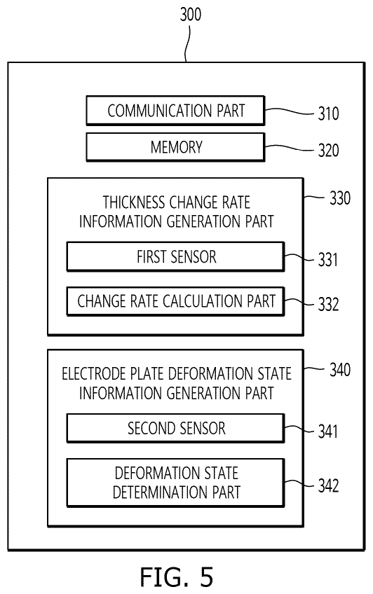

FIG. 5 illustrates the configuration of the electrode plate inspection part according to an embodiment of the present disclosure.

Referring to FIGS. 4 and 5, the electrode plate inspection part 300 according to an embodiment of the present disclosure may include a communication part 310, a memory 320, a thickness change rate information generation part 330, and an electrode plate deformation state information generation part 340.

The communication part 310 may be a device capable of communicating with the vibration generation part 100. The communication part 310 may be a device capable of wired or wireless communication with other components of the apparatus 10 for manufacturing the electrode plate. For example, the communication part 310 may wirelessly communicate with other components of the apparatus 10 for manufacturing the electrode plate by using wireless communication such as Bluetooth, RFID, Infrared Data Association, UWB, ZigBee, NFC, Wi-Fi, Wi-Fi Direct, Wireless USB, etc., but the communication may take other forms. For example, the communication part 310 may transmit thickness change rate information of the electrode plate, deformation state information of the electrode plate, etc. to the vibration generation part 100.

The memory 320 may store information related to the thickness change rate of the electrode plate, such as the thickness of the electrode plate before rolling and the properties of the active material, but the memory 320 may instead or in addition store other information. In addition, the memory 320 may additionally store information related to the deformation state of the electrode plate, such as an image of the normal state of the electrode plate after rolling.

The thickness change rate information generation part 330 may generate the thickness change rate information of the electrode plate. The thickness change rate information generation part 330 may include a first sensor 331 that measures the thickness of the electrode plate and a change rate calculation part 332 that calculates the change rate of the thickness of the electrode plate.

The change rate calculation part 332 may calculate the thickness change rate of the electrode plate by comparing the thickness of the electrode plate measured by the first sensor 331 with the thickness of the electrode plate stored in advance before rolling. For example, the thickness change rate of the electrode plate may be a ratio of the thickness of the electrode plate after rolling, which is measured by the first sensor 331, to the thickness of the electrode plate before rolling, which is stored in advance.

The electrode plate deformation state information generation part 340 may generate deformation state information of the rolled electrode plate. The electrode plate deformation state information generation part 340 may include a second sensor 341 that photographs the electrode plate to generate an electrode plate image and an electrode plate deformation state determination part 342 that determines the deformation state of the electrode plate based on the captured electrode plate image.

For example, the electrode plate deformation state determination part 342 may determine the degree to which curling, folding, bending, wrinkling, etc. have occurred in the rolled electrode plate by comparing the prestored normal plate image with the captured electrode plate image, but there are other ways to get the electrode plate deformation information. The electrode plate deformation state determination part 342 may determine the electrode plate deformation state and generate information about the electrode plate deformation state.

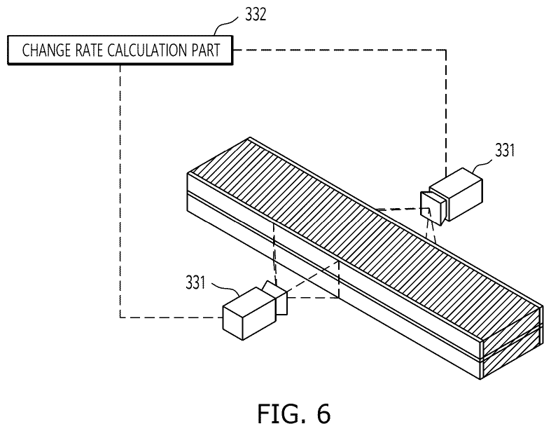

FIG. 6 illustrates an example of the thickness change rate information generation part according to an embodiment of the present disclosure.

As illustrated, the thickness change rate information generation part 330 may include a first sensor and a change rate calculation part.

In an embodiment, two sensors 331 may measure the thickness of one side and the opposite side of the rolled electrode plate, respectively. For example, the first sensor may be any one of a light sensor, a laser sensor, and an image sensor capable of measuring the size, thickness, etc. of a target object, but there are other ways to obtain the thickness change rate information.

In an embodiment, thickness information of the electrode plate measured by the first sensor may be transmitted to the change rate calculation part. The change rate calculation part may calculate the thickness change rate of the electrode plate by comparing the thickness of the electrode plate measured by the first sensor after rolling with the thickness of the electrode plate stored in advance before rolling. For example, the thickness change rate of the electrode plate may be a ratio of the thickness of the electrode plate after rolling, which is measured by the first sensor, to the thickness of the electrode plate before rolling, which may be stored in advance.

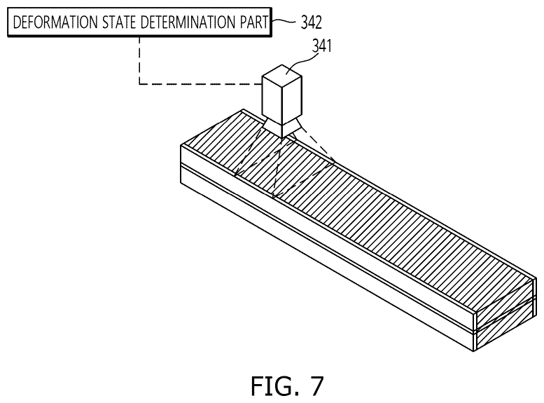

FIG. 7 illustrates an example of the electrode plate deformation state information generation part according to an embodiment of the present disclosure.

As illustrated, the electrode plate deformation state information generation part 340 may include a second sensor and a deformation state determination part.

In an embodiment, the second sensor 341 may measure the state of the upper surface (or lower surface) of the rolled electrode plate. For example, the second sensor may be an image sensor capable of capturing the surface state of the target object, but measuring the state of a surface may be done in other ways.

In an embodiment, the state information of the electrode plate measured by the second sensor 341 may be transmitted to the deformation state determination part 342. The deformation state determination part 342 may determine the deformation state of the electrode plate by comparing the state (e.g., image) of the electrode plate after rolling measured by the second sensor with the normal state (image) of the electrode plate stored in advance. For example, the deformation state of the electrode plate may be the difference between an image of the normal state of the electrode plate stored in advance and an image of the state of the electrode plate after rolling measured by the second sensor 341.

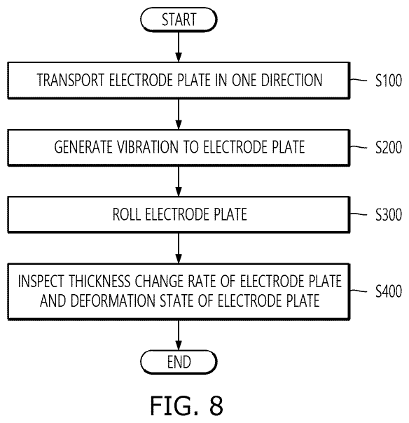

FIG. 8 illustrates a method for manufacturing an electrode plate according to another embodiment of the present disclosure.

As illustrated, the method for manufacturing the electrode plate may start with a step S100 of transporting, by the transport part 30, an electrode plate coated with an active material in one direction. For example, the transport part 30 may include a plurality of transport rollers connected to a driving motor and may transport the coated electrode plate in one direction. As another example, the transport part 30 may include a conveyor belt connected to a driving motor and transport the coated electrode plate in one direction, but the present disclosure is not limited thereto.

After or at the same time as step S100, vibration may be generated to the electrode plate by the vibration generation part 100 (S200). The vibration applied to the electrode plate may be, for example, a micro-vibration having a frequency of 500 Hz or more, but other types of vibration and the frequency may vary. The vibration generation part 100 may generate vibration corresponding to ultrasonic waves or sound waves to the electrode plate, but other waves are possible. For example, the vibration generation part 100 may include an ultrasonic wave generator 141 that generates ultrasonic vibration. In another example, the vibration generation part 100 may include a blower or an air blower that generates gas, such as air, which includes sonic or ultrasonic vibration.

In addition, the rolling part may apply pressure in the thickness direction of the electrode plate so as to thin the thickness of the electrode plate to which vibration is applied (S300). The rolling part may include a pair of rolling rollers and a rolling control part 210 that controls the pair of rolling rollers. The pair of rolling rollers may be disposed on the upper and lower surfaces of the electrode plate. The pair of rolling rollers may roll the electrode plate by applying pressure while pressing against both surfaces of the electrode plate. The pair of rolling rollers may be disposed to have a preset separation gap therebetween. The electrode plate transported by the transport part 30 may be inserted into the separation gap between the pair of rolling rollers, and the pair of rolling rollers may apply pressure to the inserted electrode plate to bring an active material into contact with the metal foil of the electrode plate.

In an embodiment, the step S200 of generating vibration to the electrode plate may include a step of generating vibration to the electrode plate by at least one of an ultrasonic wave generator 141 and an air blower 142.

In an embodiment, the step S200 of generating vibration to the electrode plate may include a step of controlling, by the vibration generation part 100, the frequency of the vibration based on the rotation speed of the rolling rollers 220a and 220b included in the rolling part.

In an embodiment, the vibration generation part 100 may be a linear or line-shaped vibration generation device capable of generating vibration from one end to the other (opposite) end of the electrode plate along the width direction of the electrode plate perpendicular to the transport direction of the electrode plate.

In an embodiment, the method for manufacturing the electrode plate may further include a step S400 of inspecting one of the thickness change rate of the rolled electrode plate and the deformation state of the electrode plate. Here, the step of inspecting the thickness change rate of the electrode plate may include a step of measuring the thickness of the rolled electrode plate and generating thickness change rate information of the electrode plate based on the measured thickness. In addition, the step of inspecting the deformation state of the electrode plate may include a step of capturing an image of the electrode plate and generating electrode plate deformation state information based on the captured image.

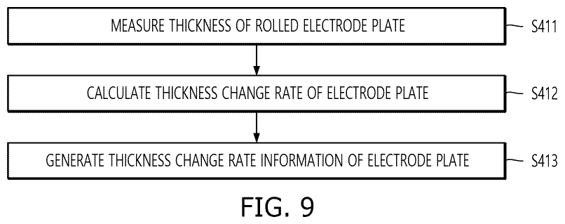

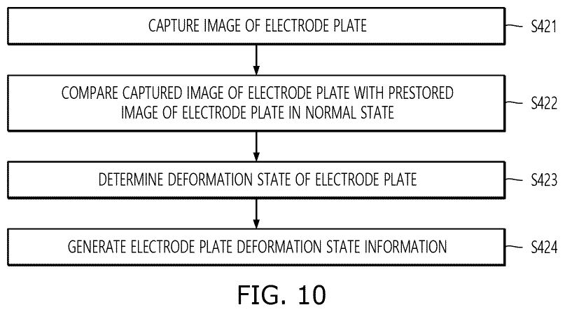

In FIGS. 9 and 10, the method for generating the thickness change rate information of the electrode plate and the method for generating the electrode plate deformation state information are described in more detail.

FIG. 9 illustrates an example of the method for generating the thickness change rate information of the electrode plate according to another embodiment of the present disclosure.

As illustrated, the method for generating the thickness change rate information of the electrode plate may begin with a step S411 of measuring the thickness of the rolled electrode plate.

In an embodiment, two first sensors may measure the thickness of one side and the opposite side of the rolled electrode plate, respectively. For example, the first sensor may be any one of a light sensor, a laser sensor, and an image sensor capable of measuring the size, thickness, etc. of a target object, but there are other ways of generating the thickness change rate information.

The thickness change rate of the electrode plate may be calculated by comparing the thickness of the electrode plate measured in step S411 with a thickness of the electrode plate measured previously (S412).

In an embodiment, thickness information of the electrode plate measured by the first sensor may be transmitted to the change rate calculation part. The change rate calculation part may calculate the thickness change rate of the electrode plate by comparing the thickness of the electrode plate measured by the first sensor after rolling with the thickness of the electrode plate stored in advance before rolling. For example, the thickness change rate of the electrode plate may be a ratio of the thickness of the electrode plate after rolling, which is measured by the first sensor, to the thickness of the electrode plate before rolling, which is stored in advance.

In addition, thickness change rate information may be generated based on the calculated thickness change rate of the electrode plate (S413).

FIG. 10 illustrates an example of the method for generating the electrode plate deformation state information according to another embodiment of the present disclosure.

As described above, the method for generating the electrode plate deformation state information may begin with a step S421 of capturing an image of the rolled electrode plate.

In an embodiment, the second sensor may measure the state of the upper surface (or lower surface) of the rolled electrode plate. For example, the second sensor may be an image sensor capable of capturing the surface state of the target object, but the type of the second sensor may vary.

The image of the electrode plate captured in step S421 may be compared with a prestored image of the normal state of the electrode plate (S422). In addition, the deformation state of the electrode plate may be determined based on the image comparison result in step S422 (S423).

In an embodiment, the state information of the electrode plate measured by the second sensor may be transmitted to the deformation state determination part. The deformation state determination part may determine the deformation state of the electrode plate by comparing the state (e.g., image) of the electrode plate after rolling measured by the second sensor with the normal state (image) of the electrode plate stored in advance. For example, the deformation state of the electrode plate may be the difference between an image of the normal state of the electrode plate stored in advance and an image of the state of the electrode plate after rolling measured by the second sensor.

In addition, the electrode plate deformation state information may be generated based on the electrode plate deformation state (S424).

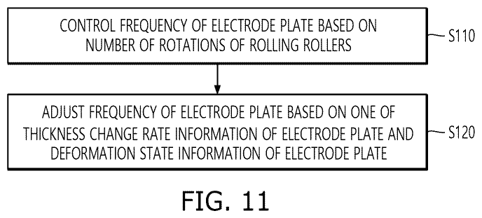

FIG. 11 illustrates an example of the method for controlling the vibration frequency of the electrode plate according to another embodiment of the present disclosure.

As described above, the method for controlling the vibration frequency of the electrode plate may begin with a step S110 of controlling one of the frequency and intensity of vibration applied to the electrode plate based on the number of rotations of the rolling rollers 220a and 220b included in the rolling part.

In an embodiment, the vibration generation part 100 may generate, to the electrode plate, ultrasonic or sonic vibration with a frequency or output intensity adjusted according to the transport speed of the electrode plate. In a case where the transport speed of the electrode plate increases, the vibration generation part 100 may increase the frequency and/or intensity of vibration. In a case where the transport speed of the electrode plate decreases, the vibration generation part 100 may decrease the frequency and/or intensity of vibration.

In an embodiment, the transport speed of the electrode plate may be proportional to the rotation speed of the rolling roller of the rolling part. In a case where the transport speed of the electrode plate increases, the rotation speed of the rolling roller may increase, and in a case where the transport speed of the electrode plate decreases, the rotation speed of the rolling roller may decrease. Accordingly, the vibration generation part 100 may generate, to the electrode plate, vibration with a frequency or output intensity adjusted in proportion to the rotation speed of the rolling roller.

In addition, one of the frequency and intensity of the vibration may be adjusted based on the thickness change rate information of the electrode plate and the deformation state information of the electrode plate (S120).

In an embodiment, after the electrode plate to which vibration generated by the vibration generation part 100 is applied is rolled by the rolling part, the thickness change rate information of the electrode plate and the deformation state information of the electrode plate may be obtained. In addition, either the thickness change rate of the rolled electrode plate or the deformation state of the electrode plate may be inspected by the electrode plate inspection part 300. Here, the thickness change rate information of the electrode plate may be generated by measuring the thickness of the rolled electrode plate and comparing the measured thickness with the thickness of the electrode plate before rolling. In addition, the deformation state information of the electrode plate may be generated by capturing the image of the electrode plate and comparing the captured image with the image of the electrode plate in the normal state.

In a case where an electrode plate is continuously rolled using a roller during a rolling process, problems such as curling, folding, bending, and wrinkles may occur due to stress accumulated in the electrode plate.

According to some embodiments of the present disclosure, vibration is generated on the electrode plate before the electrode plate is rolled in the rolling process of the electrode plate, thereby preventing stress from accumulating in the electrode plate.

According to some embodiments of the present disclosure, the effect of vibration applied to the electrode plate before the electrode plate is rolled in the rolling process of the electrode plate is monitored through vision inspection or the like, thereby further improving the effect of vibration on the electrode plate.

According to some embodiments of the present disclosure, it is possible to prevent stress from accumulating in the electrode plate in the rolling process of the electrode plate, thereby preventing deformation such as curling, folding, bending, or wrinkling from occurring in the electrode plate.

Although the present disclosure has been described above with respect to embodiments thereof, the present disclosure is not limited thereto. Various modifications and variations can be made thereto by those skilled in the art within the spirit of the present invention and the equivalent scope of the appended claims.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

### DESCRIPTION OF SOME REFERENCE SYMBOLS

10: apparatus for manufacturing electrode plate
20: electrode plate
30: transport part
100: vibration generation part
200: rolling part
300: electrode plate inspection part

What is claimed is:

1. An apparatus for manufacturing an electrode plate, the apparatus comprising:
a transport part configured to transport an electrode plate coated with an active material in one direction;
a vibration generation part configured to generate a vibration to the electrode plate; and
a rolling part configured to apply pressure in a thickness direction of the electrode plate to reduce a thickness of the electrode plate to which the vibration is applied.

2. The apparatus as claimed in claim 1, wherein the vibration generation part comprises:
a vibration generator configured to generate the vibration to the electrode plate; and
a control part configured to control one of frequency and intensity of the vibration generated by the vibration generator.

3. The apparatus as claimed in claim 2, wherein the vibration generator comprises at least one of an ultrasonic wave generator and an air blower.

4. The apparatus as claimed in claim 2, wherein the rolling part comprises a pair of rollers in close contact with each other, the pair of rollers rolling the electrode plate, and
the control part is configured to control the frequency of the vibration based on rotation speeds of the pair of rollers.

5. The apparatus as claimed in claim 4, wherein the control part is configured to control the frequency of the vibration in proportion to the rotation speeds of the pair of rollers.

6. The apparatus as claimed in claim 4, wherein a transport speed of the electrode plate by the transport part is proportional to the rotation speeds of the pair of rollers.

7. The apparatus as claimed in claim 1, wherein:
the vibration generation part is positioned ahead of the rolling part along a transport direction of the electrode plate, and
a separation distance between the vibration generation part and the rolling part is preset so that the vibration applied to the electrode plate is maintained.

8. The apparatus as claimed in claim 1, wherein the vibration generation part is configured to generate the vibration from one end of the electrode plate to an opposite end of the electrode plate along a width direction of the electrode plate, the width direction being perpendicular to a transport direction of the electrode plate.

9. The apparatus as claimed in claim 1, further comprising an electrode plate inspection part configured to inspect one of a thickness change rate of the electrode plate after passing through the rolling part and a deformation state of the electrode plate.

10. The apparatus as claimed in claim 9, wherein the electrode plate inspection part comprises:
a thickness change rate information generation part configured to generate thickness change rate information of the electrode plate;
an electrode plate deformation state information generation part configured to generate deformation state information of the electrode plate; and
a communication part configured to transmit the thickness change rate information of the electrode plate or the deformation state information of the electrode plate to the vibration generation part.

11. The apparatus as claimed in claim 10, wherein the thickness change rate information generation part comprises:
a first sensor configured to measure a thickness of the electrode plate; and
a change rate calculation part configured to calculate a thickness change rate of the electrode plate.

12. The apparatus as claimed in claim 10, wherein the electrode plate deformation state information generation part comprises:
a second sensor configured to photograph the electrode plate, the second sensor generating an electrode plate image; and
a deformation state determination part configured to determine a deformation state of the electrode plate based on the electrode plate image.

13. The apparatus as claimed in claim 9, wherein the vibration generation part comprises:
a communication part configured to receive one of the thickness change rate of the electrode plate and deformation state information of the electrode plate from the electrode plate inspection part;
a vibration generator configured to generate vibration to the electrode plate; and
a control part configured to control one of frequency and intensity of the vibration generated by the vibration generation part based on one of the thickness change rate of the electrode plate and the deformation state information of the electrode plate.

14. A method for manufacturing an electrode plate, the method comprising:
transporting, by a transport part, an electrode plate coated with an active material in one direction;
generating, by a vibration generation part, vibration to the electrode plate; and
applying, by a rolling part, pressure in a thickness direction of the electrode plate to reduce a thickness of the electrode plate to which the vibration is applied, the applying resulting in a rolled electrode plate.

15. The method as claimed in claim 14, wherein the generating of the vibration to the electrode plate comprises generating vibration to the electrode plate by at least one of an ultrasonic wave generator and an air blower.

16. The method as claimed in claim 14, wherein the rolling part comprises a pair of rollers in contact with each other, the rolling part rolling the electrode plate, and
wherein the generating of the vibration to the electrode plate comprises controlling, by the vibration generation part, a frequency of the vibration based on rotation speeds of the pair of rollers.

17. The method as claimed in claim 14, wherein the vibration generation part is configured to generate vibration from one end of the electrode plate to an opposite end of the electrode plate along a width direction of the electrode plate, the width direction being perpendicular to a transport direction of the electrode plate.

18. The method as claimed in claim 14, further comprising inspecting one of a thickness change rate of the rolled electrode plate and a deformation state of the electrode plate.

19. The method as claimed in claim 18, wherein the inspecting of the thickness change rate of the electrode plate comprises measuring the thickness of the rolled electrode plate and generating thickness change rate information of the electrode plate based on the measured thickness, and
the inspecting of the deformation state of the electrode plate comprises capturing an image of the electrode plate and generating electrode plate deformation state information based on the captured image.

20. The method as claimed in claim 18, wherein the generating of the vibration to the electrode plate comprises controlling, by the vibration generation part, one of frequency and intensity of the vibration based on information about the thickness change rate of the electrode plate and information about the deformation state of the electrode plate.
